(19) United States
(12) Patent Application Publication
(10) Pub. No.: US 2007/0070375 A1
(43) Pub. Date: Mar. 29, 2007

(54) Systems and methods for heuristics-based load balancing of hybrid PDL/raster printing

(75) Inventor: James E. Owen, Vancouver, WA (US)

Correspondence Address: MADSON & AUSTIN, 15 WEST SOUTH TEMPLE, SUITE 900, SALT LAKE CITY, UT, 84101, US

(73) Assignee: Sharp Laboratories of America, Inc.

(21) Appl. No.: 11/233,231

(22) Filed: Sep. 22, 2005

(51) Int. Cl. G06F 3/12

(52) U.S. Cl. 358/1.13; 358/1.15

(57) ABSTRACT

In an exemplary method, a raster image processing (RIP) control unit distributes raster image processing of a set of print job segments among a plurality of RIP units. The RIP control unit then monitors the availability of the plurality of RIP units. When the RIP control unit determines that one of the plurality of RIP units is available to perform additional raster image processing, the RIP control unit effects rasterization of a next print job segment by the available RIP unit. The RIP control unit continues to function in this manner until all of the segments of the print job have been rasterized.

### TECHNICAL FIELD

The present invention relates generally to computers and computer-related technology. More specifically, the present invention relates to systems and methods for heuristics-based load balancing of hybrid PDL/raster printing.

### BACKGROUND

There are many different kinds of computers in use today. The term “computer system” will be used herein to refer generally to any device or combination of devices that is capable of processing information to produce a desired result. Some examples of computer systems include personal computers, hand-held computers, personal digital assistants (PDAs), servers, mainframes, supercomputers, minicomputers, workstations, microcomputers, microcontrollers, and the like.

Document printing is a familiar task to many computer users. The term “printing device,” as used herein, refers to any device that produces human-readable text and/or graphics on an output medium, such as paper. Some examples of printing devices include computer printers, fax machines, scanners, multi-function peripherals, copiers, and so forth.

In some contexts, a computer system may be referred to as a host. To facilitate communication between a host and a printing device, the host may include a driver for the printing device. The driver for a particular printing device allows applications on the host to be able to communicate with the printing device without knowing specific details about the printing device's hardware and internal language.

One or more printing devices may be connected to a computer network. This allows the various computer systems on the network to send print jobs to the printing device(s). A print job is a single document or a set of documents that is submitted to a printing device for printing.

Raster image processing (RIP) refers to the process of converting text and/or images into a matrix of pixels (i.e., bitmap) that is ultimately printed on paper by a printing device. An RIP unit performs raster image processing. An RIP unit may be implemented using hardware and/or software components.

When a print job is sent to a printing device, the host on which the print job originated may rasterize (i.e., perform raster image processing on) the print job. Alternatively, raster image processing may be performed by an RIP unit that is located on the printing device. Alternatively still, in the context of network printing, raster image processing may be performed by one or more other RIP units that are located elsewhere on the computer network.

Where the host does not rasterize the print job, the host may generate a description of the print job using a page description language (PDL). PDLs may be used to specify the arrangement of a printed page. PDLs define page elements independently of printer technology, so that a page's appearance remains consistent regardless of the specific printing device that is used. Some examples of PDLs include the Printer Control Language (PCL), Postscript, etc. The PDL data that is generated by the host may then be provided to another RIP unit for rasterization.

The concept of load balancing is sometimes relevant when multiple RIP units are available to rasterize a print job. Load balancing the raster image processing of a print job refers to the process of distributing the raster image processing of the print job across two or more RIP units in order to avoid overloading any single RIP unit.

Some known techniques for load balancing the raster image processing of a print job involve the use of complex algorithms that take into consideration various factors, such as the host's capabilities, the printing device's capabilities, a print server's capabilities, the status of the available RIP units, RIP unit statistics, network capacity, network performance, graphics commands statistics, and so forth. However, known approaches suffer from various drawbacks. Accordingly, benefits may be realized by improved systems and methods for load balancing the raster imaging processing of a print job. Some exemplary systems and methods for load balancing the raster imaging processing of a print job are described herein.

### BRIEF DESCRIPTION OF THE DRAWINGS

Exemplary embodiments of the invention will become more fully apparent from the following description and appended claims, taken in conjunction with the accompanying drawings. Understanding that these drawings depict only exemplary embodiments and are, therefore, not to be considered limiting of the invention's scope, the exemplary embodiments of the invention will be described with additional specificity and detail through use of the accompanying drawings in which:

FIG. 1 is a block diagram that illustrates various components in an embodiment of a system for heuristics-based load balancing of hybrid PDL/raster printing, including a plurality of raster image processing (RIP) units and an RIP control unit;

FIG. 2 is a block diagram that illustrates the operation of the RIP control unit in some embodiments after an initial set of print job segments has been distributed among available RIP units;

FIG. 3 is a block diagram that illustrates various components in another embodiment of a system for heuristics-based load balancing of hybrid PDL/raster printing, including a plurality of raster image processing (RIP) units and an RIP control unit located on a print server;

FIG. 4 is a block diagram that illustrates the operation of the RIP control unit in some embodiments in order to arbitrarily distribute an initial set of print job segments among available RIP units;

FIG. 5 is a block diagram that illustrates the operation of the RIP control unit in some embodiments after an initial set of print job segments has been distributed among available RIP units;

FIG. 6 is a flow diagram that illustrates an embodiment of a method for heuristics-based load balancing of hybrid PDL/raster printing;

FIG. 7 illustrates an exemplary way that the graphics commands of a print job may be sorted into segments;

FIGS. 8A through 8B illustrate another exemplary way that the graphics commands of a print job may be sorted into segments; and

FIG. 9 is a block diagram illustrating the major hardware components typically utilized in a computer system.

### DETAILED DESCRIPTION

A method for heuristics-based load balancing of hybrid PDL/raster printing is disclosed. The method may be implemented by a raster image processing (RIP) control unit that is in electronic communication with a printing device driver. In response to a print job being generated on a host, the RIP control unit distributes raster image processing of a set of print job segments among the plurality of RIP units. The RIP control unit then monitors the availability of the RIP units. When the RIP control unit determines that a particular RIP unit is available to perform additional raster image processing, the RIP control unit effects rasterization of the next print job segment by the available RIP unit.

In some embodiments, the driver receives graphics commands corresponding to the print job, and sorts the graphics commands into the set of print job segments. Each print job segment may be a page band.

The raster image processing of the set of print job segments may be distributed arbitrarily among the RIP units. After the raster image processing of the set of print job segments has been distributed among the RIP units, the step of effecting rasterization of the next print job segment by the available RIP unit may be performed whenever it is determined that one of the RIP units is available to perform additional raster image processing. This may continue to be performed until all of the print job segments have been rasterized.

In order to distribute the raster image processing of the set of print job segments among N available RIP units, the RIP control unit may instruct the host to rasterize graphics commands that correspond to a single print job segment. The RIP control unit may also instruct the host to render graphics commands that correspond to N−1 print job segments into page description language (PDL) data.

In some embodiments, the RIP control unit may be located on the host. Alternatively, the RIP control unit may be located on a print server that is in electronic communication with the host.

The steps that are taken to effect rasterization of the next print job segment may depend on whether the available RIP unit is located on the host. If the available RIP unit is located on the host, the RIP control unit may instruct the host to rasterize graphics commands that correspond to the next print job segment. However, if the available RIP unit is not located on the host, the RIP control unit may instruct the host to render the graphics commands that correspond to the next print job segment into PDL data.

In some embodiments, the step of monitoring the availability of the RIP units involves waiting to receive availability notification messages from the RIP units. Alternatively, this step may involve sending availability inquiries to the RIP units. The RIP control unit may determine that a particular RIP unit is available to perform additional raster image processing when it receives an availability notification message from the RIP unit.

A computer system that is configured to implement a method for heuristics-based load balancing of hybrid PDL/raster printing is also disclosed. The computer system includes a processor, and memory in electronic communication with the processor. Instructions are stored in the memory. The instructions are executable to implement the method described above for heuristics-based load balancing of hybrid PDL/raster printing. A computer-readable medium comprising executable instructions for implementing a method for heuristics-based load balancing of hybrid PDL/raster printing is also disclosed.

Various embodiments of the invention are now described with reference to the Figures, where like reference numbers indicate identical or functionally similar elements. The embodiments of the present invention, as generally described and illustrated in the Figures herein, could be arranged and designed in a wide variety of different configurations. Thus, the following more detailed description of several exemplary embodiments of the present invention, as represented in the Figures, is not intended to limit the scope of the invention, as claimed, but is merely representative of the embodiments of the invention.

The word “exemplary” is used exclusively herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

Many features of the embodiments disclosed herein may be implemented as computer software, electronic hardware, or combinations of both. To clearly illustrate this interchangeability of hardware and software, various components will be described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Where the described functionality is implemented as computer software, such software may include any type of computer instruction or computer executable code located within a memory device and/or transmitted as electronic signals over a system bus or network. Software that implements the functionality associated with components described herein may comprise a single instruction, or many instructions, and may be distributed over several different code segments, among different programs, and across several memory devices.

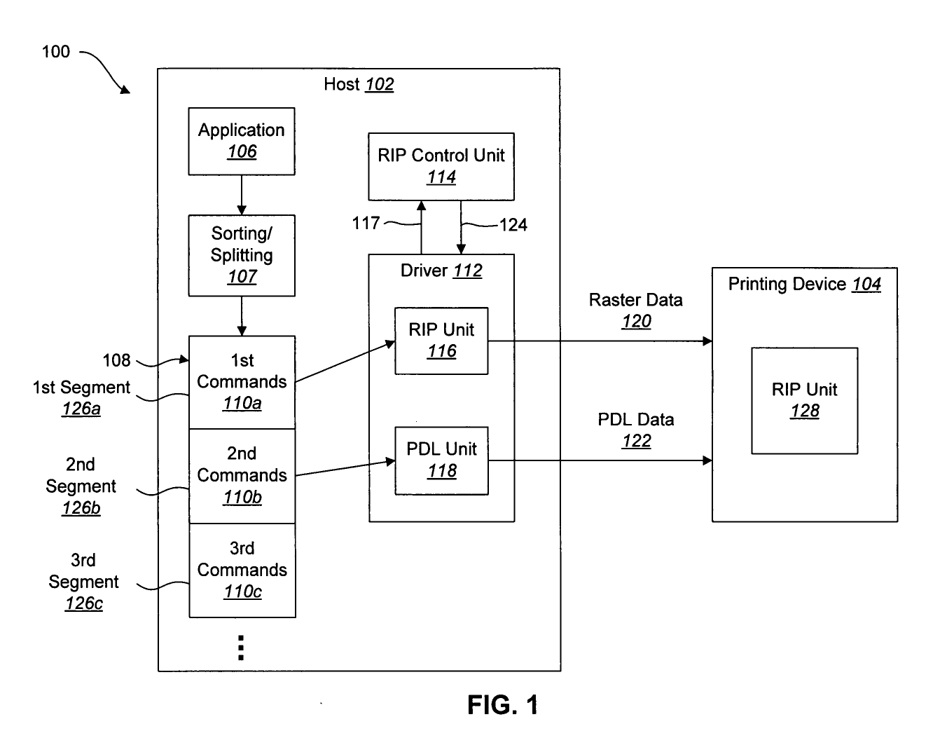

FIG. 1 illustrates the operation of various components in an embodiment of a system 100 for heuristics-based load balancing of hybrid PDL/raster printing. The system 100 includes a host 102 that is in electronic communication with a printing device 104. When an application 106 on the host 102 is instructed to print one or more documents on the printing device 104 (e.g., by a user, a scheduled task, etc.), the application 106 generates a print job 108. The print job 108 includes graphics commands 110. In a Microsoft Windows® environment, the graphics commands 110 may be graphics device interface (GDI) commands. The graphics commands 110 are provided to a driver 112 for the printing device 104.

A sorting/splitting component 107 sorts the graphics commands 110 of the print job 108 into segments 126. In some embodiments, each segment 126 may be a page band, i.e., a portion of a page of the print job 108. Where graphics commands 110 span multiple segments 126, the sorting/splitting component 107 splits the graphics commands 110 so that each command 110 corresponds to a single segment 126. In the illustrated embodiment, the sorting component 107 sorts the print job 108 into a first segment 126a, a second segment 126b, a third segment 126c, and so on. The first segment 126a includes a first set of graphics commands 110a. The second segment 126b includes a second set of graphics commands 110b. The third segment 126c includes a third set of graphics commands 110c.

The sorting component 107 may be part of the driver 112. Alternatively, the step of sorting the graphics commands 110 into segments 126 may be performed by the operating system (not shown) or the application 106. In some embodiments, if the operating system performs the sorting step, the driver 112 may notify the operating system that the driver is a “banding driver”. The operating system may then replay the list of graphics commands 110 once per band and give the driver 112 the rectangle that corresponds to the current band. The driver 112 may clip out all the extra graphics commands 110 that are not in the current band.

The driver 112 includes an RIP unit 116. The RIP unit 116 is configured to perform raster image processing. In other words, the RIP unit 116 is configured to convert the graphics commands 110 into raster data 120, which is the matrix of pixels (i.e., bitmap) that is ultimately printed on paper by the printing device 104.

The driver 112 also includes a page description language (PDL) unit 118. The PDL unit 118 is configured to convert the graphics commands 110 into PDL data 122. The PDL data 122 specifies the arrangement of the various elements (e.g., text, images, etc.) of the print job 108. The PDL data 122 may be PostScript data, Printer Command Language (PCL) data, etc.

Typically, when the driver 112 receives graphics commands 110 for a print job 108, either the RIP unit 116 of the driver 112 rasterizes the graphics commands 110, or the PDL unit 118 of the driver 112 renders the graphics commands 110 into PDL data 122. If the PDL unit 118 renders the graphics commands 110 into PDL data 122, the PDL data 122 is typically provided to an RIP unit on another device (such as the RIP unit 128 on the printing device 104) for rasterization. In the illustrated embodiment, the host 102 includes an RIP control unit 114 that determines whether the driver 112 should rasterize the graphics commands 110 or render them into PDL data 122.

When the driver 112 receives graphics commands 110 for the print job 108, the driver 112 sends a request 117 to the RIP control unit 114 for instructions regarding how the graphics commands 110 for the print job 108 should be processed. In particular, the driver 112 requests instructions concerning whether the driver 112 should rasterize the graphics commands 110 or render the graphics commands 110 into PDL data 122.

The RIP control unit 114 responds to the request 117 with instructions 124. In particular, the RIP control unit 114 identifies the RIP units that are available to assist with rasterization of the print job 108, and arbitrarily distributes the raster image processing of the various segments 126 of the print job 108 among these RIP units.

In general terms, the RIP control unit 114 instructs the driver 112 on the host 102 to rasterize the graphics commands 110 that correspond to a single print job segment 126, and to render the graphics commands 110 that correspond to N−1 print job segments 126 into PDL data 122 (where N is the number of available RIP units in the system 100). In the illustrated embodiment, there are two available RIP units, namely the RIP unit 116 on the host 102 and the RIP unit 128 on the printing device 104. Therefore, the RIP control unit 114 instructs the driver 112 to rasterize the first set of graphics commands 110a that correspond to the first print job segment 126a, and to render the second set of graphics commands 110b that correspond to the second print job segment 126b into PDL data 122.

In response to the instructions 124 provided by the RIP control unit 114, the first set of graphics commands 110a that correspond to the first print job segment 126a are provided to the RIP unit 116 of the driver 112. The RIP unit 116 rasterizes this first set of graphics commands 110a, thereby generating raster data 120, which is provided to the printing device 104. The second set of graphics commands 110b that correspond to the second print job segment 126b is provided to the PDL unit 118 of the driver 112. The PDL unit 118 renders this second set of graphics commands 110b into PDL data 122, which is provided to the printing device 104. The RIP unit 128 on the printing device 104 rasterizes the PDL data 122.

The RIP control unit 114 does not initially instruct the driver 112 about how to process all of the segments 126 of the print job 108. Rather, the RIP control unit 114 only provides instructions for processing enough print job segments 126 so that all of the RIP units in the system 100 are busy. In the illustrated embodiment, because there are only two RIP units in the system 100, the RIP control unit 114 does not initially instruct the driver 112 how the third set of graphics commands 110c that correspond to the third print job segment 126c should be processed. As will be explained below, the instructions that the RIP control unit 114 provides about how the third print job segment 126c should be processed may depend on whether the RIP unit 116 on the host 102 or the RIP unit 128 on the printing device 104 first becomes available to rasterize the third print job segment 126c.

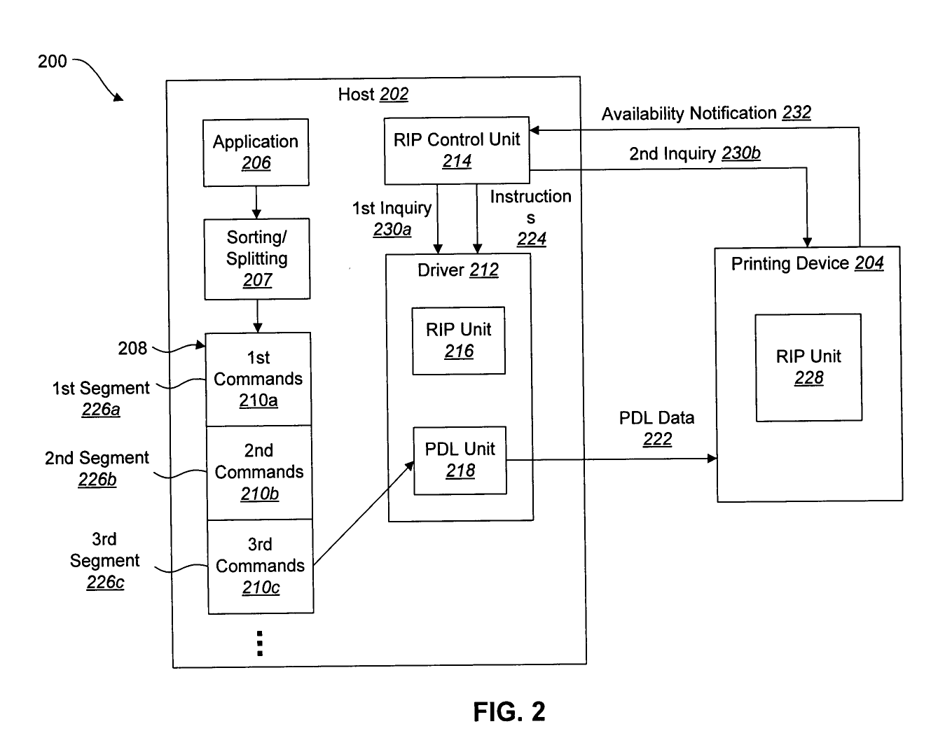

FIG. 2 illustrates the operation of an RIP control unit 214 in some embodiments after an initial set of segments 226 of a print job 208 that was generated by an application 206 has been distributed among multiple RIP units for rasterization. The print job 208 has been sorted into segments 226 by a sorting/splitting component 207. A first set of graphics commands 210a that correspond to a first print job segment 226a and a second set of graphics commands 210b that correspond to a second print job segment 226b have been distributed among an RIP unit 216 on the host 202 and an RIP unit 228 on the printing device 204 for rasterization.

The RIP control unit 214 monitors the availability of the RIP units in the system 200. In the illustrated embodiment, the RIP control unit 214 performs this task by sending availability inquiries 230 to the RIP units. In particular, the RIP control unit 214 sends a first availability inquiry 230a to the RIP unit 216 on the host 202. In addition, the RIP control unit 214 sends a second availability inquiry 230b to the RIP unit 228 on the printing device 204.

In the illustrated embodiment, the RIP unit 228 on the printing device 204 is available to perform raster image processing when it receives the second availability inquiry 230b from the RIP control unit 214. Therefore, the RIP unit 228 responds by sending an availability notification message 232 indicating that the RIP unit 228 is available to perform additional raster image processing. However, the RIP unit 216 on the host 202 is not available to perform additional raster image processing when it receives the first availability inquiry 230a from the RIP control unit 214. Therefore, the RIP unit 216 on the host 202 does not send an availability notification message back to the RIP control unit 214.

When the RIP control unit 214 receives the availability notification message 232 from the RIP unit 228 on the printing device 204, the RIP control unit 214 determines that this RIP unit 228 is available to perform additional raster image processing. In response, the RIP control unit 214 effects rasterization of the next segment 226c of the print job 208 by this RIP unit 228. In the illustrated embodiment, this involves providing instructions 224 to the driver 212 on the host 202 to render the next set of graphics commands (i.e., the third set of graphics commands 210c that correspond to the third print job segment 226c) into PDL data 222. In response to these instructions 224, the third set of graphics commands 210c that correspond to the third print job segment 226c is provided to the PDL unit 218 of the driver 212. The PDL unit 218 renders the third set of graphics commands 210c into PDL data 222. The PDL data 222 is provided to the printing device 204. The RIP unit 228 on the printing device 204 then rasterizes the PDL data 222.

The print job 208 may include additional segments 226. The RIP control unit 214 continues to monitor the availability of the RIP units in the system 200. Whenever the RIP control unit 214 determines that one of the RIP units in the system 200 is available to perform additional raster image processing, the RIP control unit 214 effects rasterization of the next print job segment 226 by the available RIP unit. The RIP control unit 214 continues to function in this manner until all of the segments 226 of the print job 208 have been rasterized.

In the illustrated embodiment, a pull mechanism is utilized to monitor the availability of the RIP units in the system 200. In particular, the RIP control unit 214 sends availability inquiries 230 to the RIP units, and each RIP unit sends back an availability notification message 232 if it is available for additional raster image processing. In alternative embodiments, a push mechanism may be utilized to monitor the availability of the RIP units. In other words, each RIP unit may send an availability notification message 232 to the RIP control unit 214 whenever it is available to perform additional raster image processing, and the RIP control unit 214 may simply wait to receive the availability notification messages 232 from the RIP units without sending out availability inquiries 230.

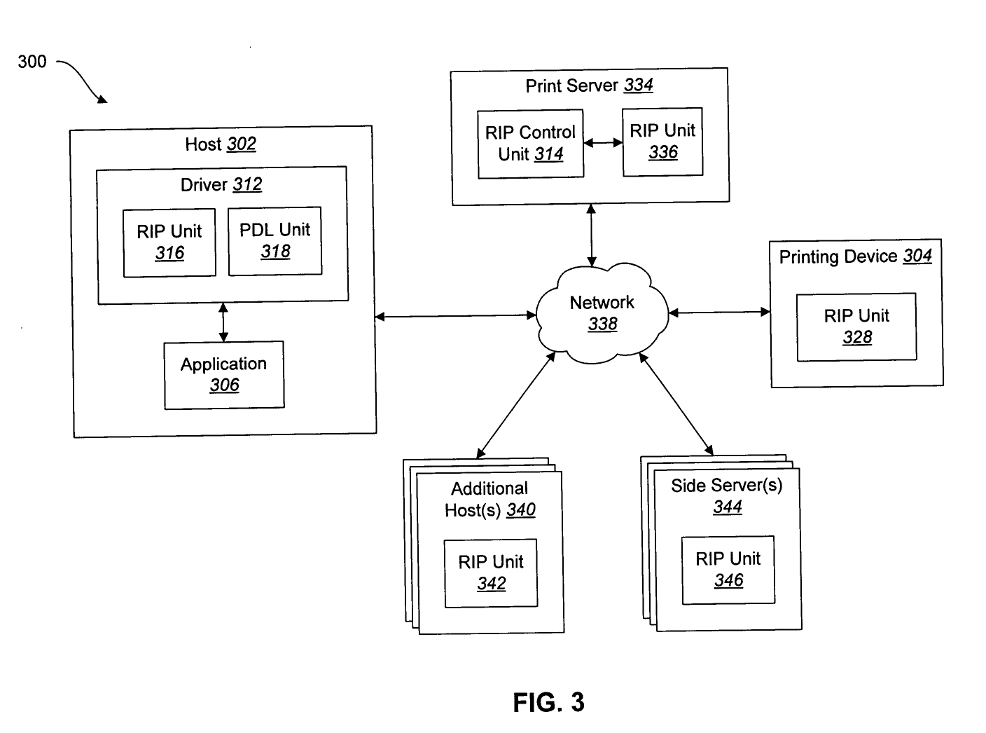

FIG. 3 illustrates another embodiment of a system 300 for heuristics-based load balancing of hybrid PDL/raster printing. As before, the system 300 includes a host 302 that is in electronic communication with a printing device 304. Communication between the host 302 and the printing device 304 may occur via a computer network 338. The host 302 includes a driver 312 for the printing device 304. The driver 312 includes an RIP unit 316 and a PDL unit 318. An application 306 on the host 302 communicates with the printing device 304 via the driver 312.

In the embodiments discussed above in connection with FIGS. 1 and 2, an RIP control unit was located on the host. In contrast, the system 300 shown in FIG. 3 includes a print server 334, and the RIP control unit 314 is located on the print server 334. The print server 334 is in electronic communication with the host 302 and the printing device 304 via the network 338.

As before, the host 302 includes an RIP unit 316, and the printing device 304 includes an RIP unit 328. In addition, there are several other RIP units in the system 300 shown in FIG. 3. In particular, the print server 334 includes an RIP unit 336. Also, one or more RIP units 342 may be included on one or more additional hosts 340 that are connected to the network 338. Also, one or more RIP units 346 may be included on one or more side servers 344 that are connected to the network 338.

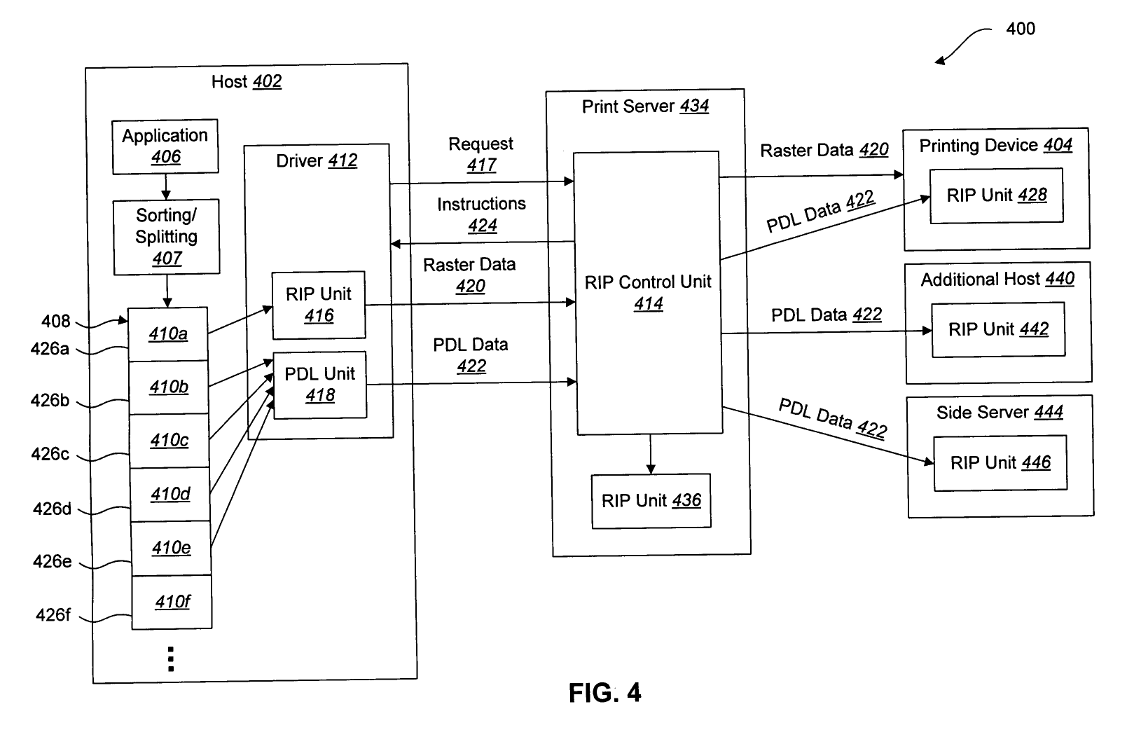

FIG. 4 illustrates the operation of various components in an embodiment of a system 400 for heuristics-based load balancing of hybrid PDL/raster printing that is similar to the system 300 shown in FIG. 3. When an application 406 on the host 402 is instructed to print one or more documents on the printing device 404 (e.g., by a user, a scheduled task, etc.), the application 406 generates a print job 408. The print job 408 includes graphics commands 410. The graphics commands 410 are provided to a driver 412 for the printing device 404.

A sorting/splitting component 407 sorts the print job 408 into segments 426. As before, where graphics commands 410 span multiple segments 426, the sorting/splitting component 407 splits the graphics commands 410 so that each command 410 corresponds to a single segment 426. In the illustrated embodiment, the sorting component 407 sorts the print job 408 into a first segment 426a, a second segment 426b, a third segment 426c, a fourth segment 426d, a fifth segment 426e, a sixth segment 426f, and so on. The first segment 426a includes a first set of graphics commands 410a. The second segment 426b includes a second set of graphics commands 410b. The third segment 426c includes a third set of graphics commands 410c. The fourth segment 426d includes a fourth set of graphics commands 410d. The fifth segment 426e includes a fifth set of graphics commands 410e. The sixth segment 426f includes a sixth set of graphics commands 410f.

The driver 412 sends a request 417 to an RIP control unit 414 on a print server 434 for instructions regarding how to process the graphics commands 410. The RIP control unit 414 responds to the request 417 with instructions 424. The RIP control unit 414 identifies the RIP units that are available to assist with rasterization of the print job 408, and arbitrarily distributes the raster image processing of an initial set of the print job segments 426 among these RIP units.

More specifically, the RIP control unit 414 instructs the driver 412 on the host 402 to rasterize the graphics commands 410 that correspond to a single print job segment 426, and to render the graphics commands 410 that correspond to N−1 print job segments 426 into PDL data 422 (where N is the number of available RIP units). In the illustrated embodiment, there are five RIP units, namely the RIP unit 416 on the host 402, the RIP unit 436 on the print server 434, the RIP unit 428 on the printing device 404, the RIP unit 442 on the additional host 440, and the RIP unit 446 on the side server 444. The RIP control unit 414 instructs the driver 412 to rasterize the first set of graphics commands 410a that corresponds to the first print job segment 426a. In addition, the RIP control unit 414 instructs the driver 412 to render the following sets of graphics commands into PDL data 422: the second set of graphics commands 410b that corresponds to the second print job segment 426b, the third set of graphics commands 410c that corresponds to the third print job segment 426c, the fourth set of graphics commands 410d that corresponds to the fourth print job segment 426d, and the fifth set of graphics commands 410e that corresponds to the fifth print job segment 426e.

In response to the instructions 424 provided by the RIP control unit 414, the first set of graphics commands 410a that corresponds to the first print job segment 426a is provided to the RIP unit 416 of the driver 412. The RIP unit 416 rasterizes the first set of graphics commands 410a, thereby generating raster data 420. The raster data 420 is provided to the print server 434, which sends the raster data 420 to the printing device 404. The second set of graphics commands 410b, third set of graphics commands 410c, fourth set of graphics commands 410d, and fifth set of graphics commands 410e are provided to the PDL unit 418. The PDL unit 418 renders these sets of graphics commands 410b, 410c, 410d, 410e into PDL data 422. The PDL data 422 is provided to the print server 434. The print server 434 sends the PDL data 422 corresponding to different print job segments 426 to the various RIP units in the system 400 for rasterization.

As before, the RIP control unit 414 does not initially instruct the driver 412 about how to process all of the segments 426 of the print job 408. Rather, the RIP control unit 414 only provides instructions for processing enough print job segments 426 so that all of the RIP units in the system are busy. In the illustrated embodiment, because there are five RIP units in the system 400, the RIP control unit 414 does not initially instruct the driver 412 how the graphics commands 410f that correspond to the sixth print job segment 426f should be processed. As will be explained below, the instructions that the RIP control unit 414 provides about how this print job segment 426f should be processed may depend on which RIP unit first becomes available to rasterize this print job segment 426f.

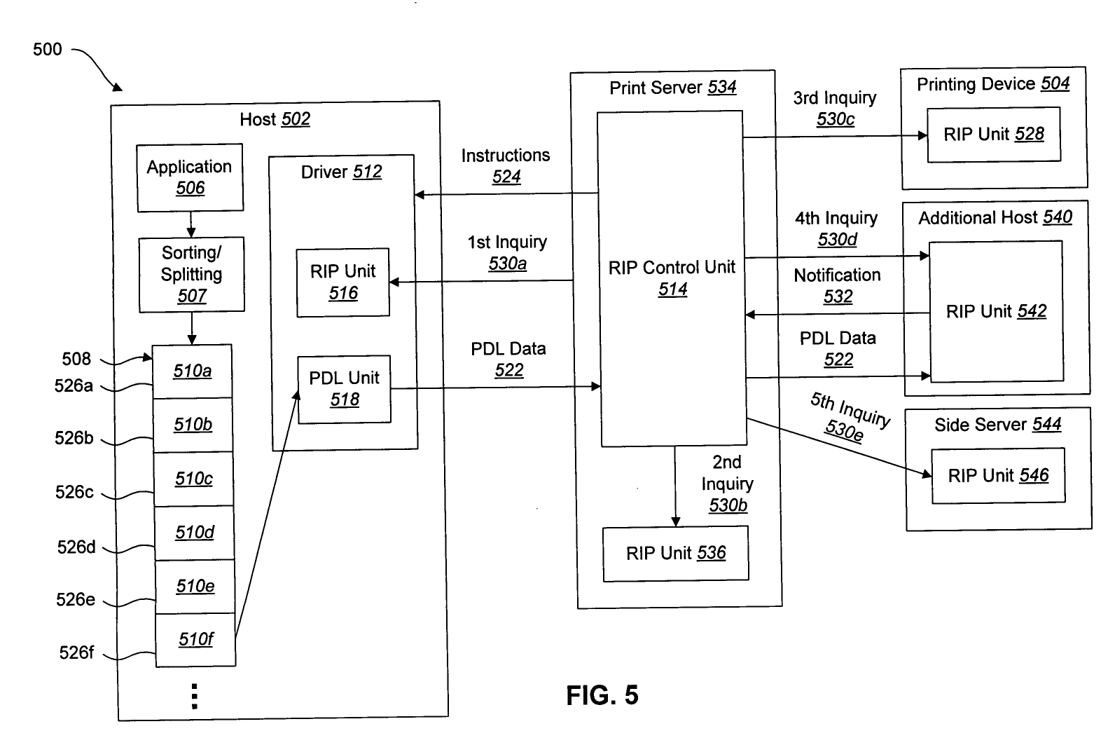

FIG. 5 illustrates the operation of an RIP control unit 514 in some embodiments after an initial set of segments 526 of a print job 508 that was generated by an application 506 has been distributed among multiple RIP units for rasterization. The print job 508 has been sorted into segments 526 by a sorting/splitting component 507. A first set of graphics commands 510a that correspond to a first print job segment 526a, a second set of graphics commands 510b that correspond to a second print job segment 526b, a third set of graphics commands 510c that correspond to a third print job segment 526c, a fourth set of graphics commands 510d that correspond to a fourth print job segment 526d, and a fifth set of graphics commands 510e that correspond to a fifth print job segment 526e have been distributed among an RIP unit 516 on a host 502, an RIP unit 536 on a print server 534, an RIP unit 528 on a printing device 504, an RIP unit 542 on an additional host 540, and an RIP unit 546 on a side server 544 for rasterization.

The RIP control unit 514 monitors the availability of the RIP units in the system 500. In the illustrated embodiment, the RIP control unit 514 performs this task by sending availability inquiries 530 to the RIP units. In particular, the RIP control unit 514 sends a first availability inquiry 530a to the RIP unit 516 on the host 502, a second availability inquiry 530b to the RIP unit 536 on the print server 534, a third availability inquiry 530c to the RIP unit 528 on the printing device 504, a fourth availability inquiry 530d to the RIP unit 542 on the additional host 540, and a fifth availability inquiry 530e to the RIP unit 546 on the side server 544.

In the illustrated embodiment, the RIP unit 542 on the additional host 540 is available to perform raster image processing when it receives the fourth availability inquiry 530d from the RIP control unit 514. Therefore, this RIP unit 542 responds by sending an availability notification message 532 indicating that the RIP unit 542 is available to perform additional raster image processing. However, the RIP unit 516 on the host 502, the RIP unit 536 on the print server 534, the RIP unit 528 on the printing device 504, and the RIP unit 546 on the side server 544 are not available to perform additional raster image processing when they receive availability inquiries 530 from the RIP control unit 514. Therefore, these RIP units 516, 536, 528, 546 do not send availability notification messages back to the RIP control unit 514.

When the RIP control unit 514 receives the availability notification message 532 from the RIP unit 542 on the additional host 540, the RIP control unit 514 determines that the RIP unit 542 is available to perform additional raster image processing. In response, the RIP control unit 514 effects rasterization of the next print job segment 526 by this RIP unit 542. More specifically, the RIP control unit 514 provides instructions 524 to the driver 512 on the host 502 to render the set of graphics commands 510 that corresponds to the next print job segment 526 (i.e., the sixth set of graphics commands 510f that corresponds to the sixth print job segment 526f) into PDL data 522. In response to these instructions 524, the set of graphics commands 510f that corresponds to the next print job segment 526f is provided to the PDL unit 518 of the driver 512. The PDL unit 518 renders this set of graphics commands 510f into PDL data 522. The PDL data 522 is provided to the print server 534, which sends the PDL data 522 to the additional host 540. The RIP unit 542 on the additional host 540 then rasterizes the PDL data 522. The resulting raster data (not shown) may then be provided to the printing device 504.

As before, the print job 508 may include additional segments 526. The RIP control unit 514 continues to monitor the availability of the RIP units in the system 50.0. Whenever the RIP control unit 514 determines that one of the RIP units in the system 500 is available to perform additional raster image processing, the RIP control unit 514 effects rasterization of the next print job segment 526 by the available RIP unit. The RIP control unit 514 continues to function in this manner until all of the segments 526 of the print job 508 have been rasterized.

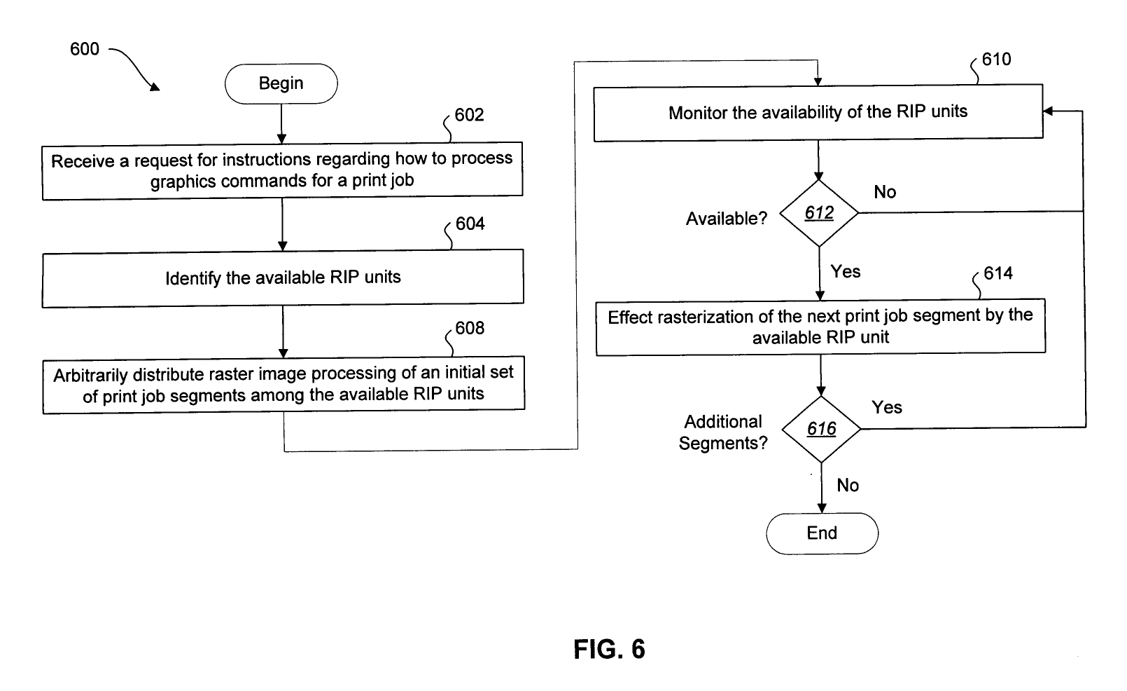

FIG. 6 is a flow diagram that illustrates an embodiment of a method 600 for heuristics-based load balancing of hybrid PDL/raster printing. The method 600 may be implemented by an RIP control unit 114. As indicated above, the RIP control unit 114 may be located on a host 102 on which a print job 108 originates. Alternatively, the RIP control unit 414 may be located on a print server 434 that is in electronic communication with the host 402 on which a print job 408 originates.

The method 600 begins when the RIP control unit 114 receives 602 a request from a printing device driver 112 for instructions regarding how to process graphics commands 110 for a print job 108. The graphics commands 110 have been sorted into segments 126 by a sorting component 107. Each segment 126 may be a page band, i.e., a portion of a page of the print job 108. In response to the request, the RIP control unit 114 identifies 604 the RIP units that are available to assist with rasterization of the print job 108.

The RIP control unit 114 arbitrarily distributes 608 raster image processing of an initial set of print job segments 126 among the available RIP units. In some embodiments, this step may involve instructing the driver 112 on the host 102 to rasterize the graphics commands 110 that correspond to a single print job segment 126, and to render the graphics commands 110 that correspond to N−1 print job segments 126 into PDL data 122 (where N is the number of available RIP units).

The RIP control unit 114 monitors 610 the availability of the RIP units. In some embodiments, the RIP control unit 114 may perform this task by sending availability inquiries to the RIP units. Alternatively, the RIP control unit 114 may perform this task by simply waiting to receive availability notification messages from the RIP units.

The RIP control unit 114 continues to monitor 610 the availability of the RIP units until the RIP control unit 114 determines 612 that one of the RIP units is available to perform additional raster image processing. When this occurs, the RIP control unit 114 effects 614 rasterization of the next print job segment by the available RIP unit.

The RIP control unit 114 determines 616 whether there are additional print job segments 126 to rasterize. If there are additional print job segments 126, the method 600 returns to step 610 and proceeds as described above. However, if in step 616 it is determined that there are not any additional print job segments 126 to be rasterized, the method 600 ends.

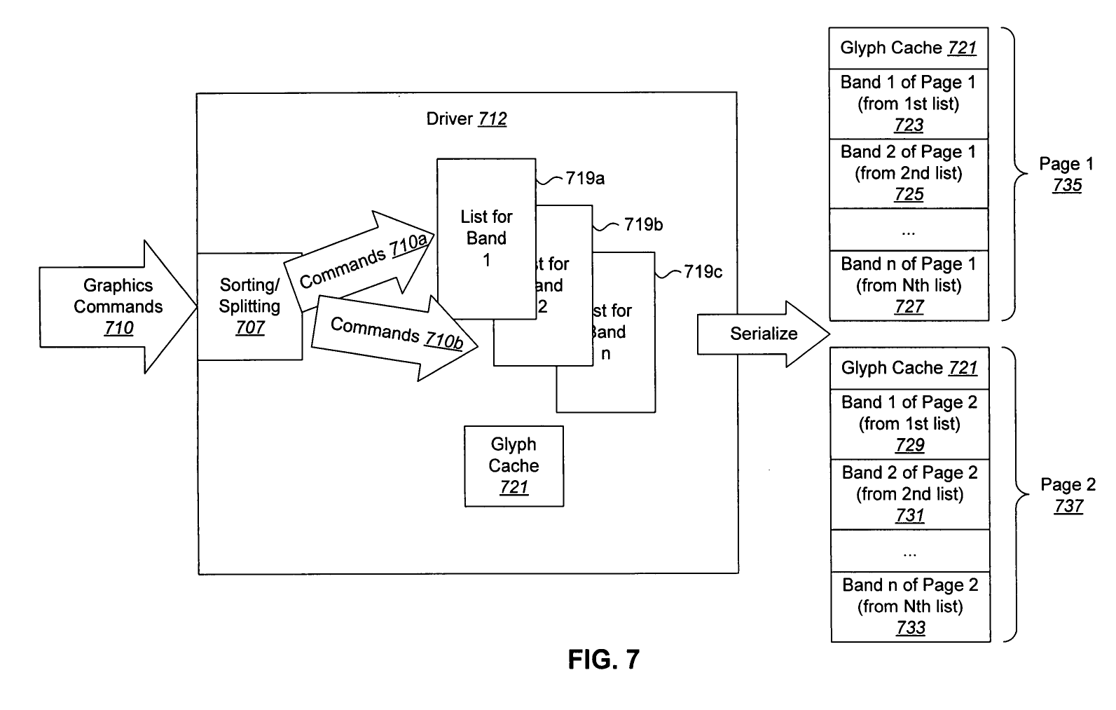

FIG. 7 illustrates an exemplary way that the graphics commands of a print job may be sorted into segments. The driver shown in FIG. 7 includes a sorting/splitting component 707. When the sorting/splitting component 707 receives graphics commands 710 for a print job, the sorting/splitting component 707 sorts the graphics commands 710 into print job segments. In particular, the sorting/splitting component 707 converts the graphics commands 710 into a first set of graphics commands 710a that corresponds to a first page band, a second set of graphics commands 710b that corresponds to a second page band, and so on. As before, where graphics commands 710 span multiple segments, the sorting/splitting component 707 splits the graphics commands 710 so that each command 710 corresponds to a single segment.

The sorting/splitting component 707 then creates a separate list 719 for each page band. Each list 719 includes the graphics commands 710 that corresponds to a particular page band for all pages of the document to be printed. In particular, a first list 719a, a second list 719b, and an Nth list 719c are created. The first list 719a comprises the graphics commands that correspond to the first page band for all pages of the document to be printed. The second list 719b comprises the graphics commands that correspond to the second page band for all pages of the document to be printed. The Nth list 719c comprises the graphics commands that correspond to the Nth page band for all pages of the document to be printed. The driver 712 also creates a glyph cache 721.

The driver 712 then serializes the different lists 719, i.e., assembles the graphics commands from the different lists into pages. The first page 735 includes the glyph cache 721, the graphics commands 723 that correspond to the first page band on the first page (taken from the first list 719a), the graphics commands 725 that correspond to the second page band on the first page (taken from the second list 719b), and so on, including the graphics commands 727 that correspond to the Nth page band on the first page (taken from the Nth list 719c). The second page 737 includes the glyph cache 721, the graphics commands 729 that correspond to the first page band on the second page (taken from the first list 719a), the graphics commands 731 that correspond to the second page band on the second page (taken from the second list 719b), and so on, including the graphics commands 733 that correspond to the Nth page band on the second page (taken from the Nth list 719c).

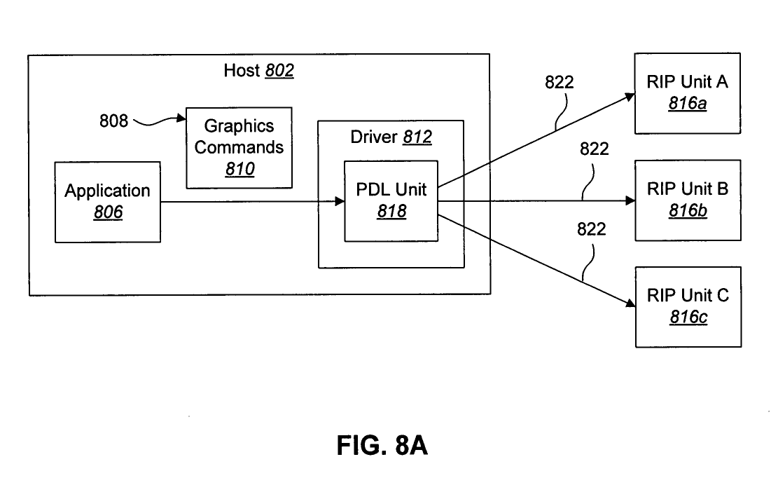

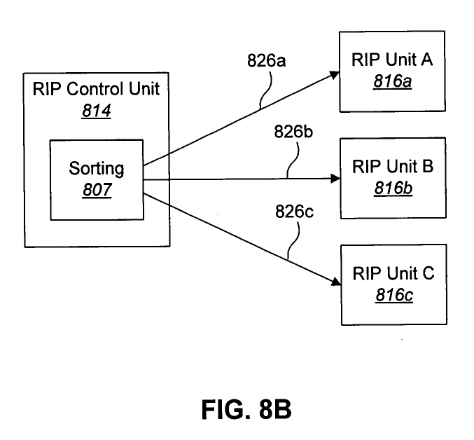

FIGS. 8A through 8B illustrate another exemplary way that the graphics commands of a print job may be sorted into segments. As shown in FIG. 8A, when an application 806 on a host 802 is instructed to print one or more documents, the application 806 generates a print job 808 that includes graphics commands 810. In the illustrated embodiment, however, the driver 812 does not the sort the graphics commands 810 into segments. Rather, the graphics commands 810 are provided to a PDL unit 818 within the driver 812, which converts the graphics commands 810 into PDL data 822. The PDL data 822 is then sent to the RIP units 816 in the system, namely, RIP unit A 816a, RIP unit B 816b, and RIP unit C 816c. As shown in FIG. 8B, the RIP control unit 814 includes a sorting component 807 that sorts the graphics commands 810 of the print job into segments 826. The segments 826 (rectangle coordinates) may then be sent to the RIP units 816 for rasterization in the manner outlined above. In particular, the RIP control unit 814 may arbitrarily distribute the raster image processing of an initial set of segments 826 of the print job 808 among the RIP units 816 in the system. Then, the RIP control unit 814 may assign additional segments 826 to RIP units 816 as the RIP units 816 become available. In FIG. 8B, a first segment 826a is shown being sent to RIP unit A 816a, a second segment 826b is shown being sent to RIP unit B 816b, and a third segment 826c is shown being sent to RIP unit C 816c.

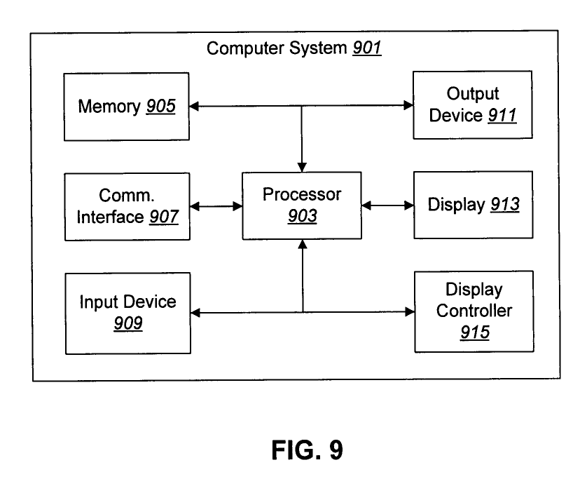

FIG. 9 is a block diagram illustrating the major hardware components typically utilized in a computer system 901. The illustrated components may be located within the same physical structure or in separate housings or structures.

The computer system 901 includes a processor 903 and memory 905. The processor 903 controls the operation of the computer system 901 and may be embodied as a microprocessor, a microcontroller, a digital signal processor (DSP) or other device known in the art. The processor 903 typically performs logical and arithmetic operations based on program instructions stored within the memory 905.

As used herein, the term memory 905 is broadly defined as any electronic component capable of storing electronic information, and may be embodied as read only memory (ROM), random access memory (RAM), magnetic disk storage media, optical storage media, flash memory devices in RAM, on-board memory included with the processor 903, EPROM memory, EEPROM memory, registers, etc. The memory 905 typically stores program instructions and other types of data. The program instructions may be executed by the processor 903 to implement some or all of the methods disclosed herein.

The computer system 901 typically also includes one or more communication interfaces 907 for communicating with other electronic devices. The communication interfaces 907 may be based on wired communication technology, wireless communication technology, or both. Examples of different types of communication interfaces 907 include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, and so forth.

The computer system 901 typically also includes one or more input devices 909 and one or more output devices 911. Examples of different kinds of input devices 909 include a keyboard, mouse, microphone, remote control device, button, joystick, trackball, touchpad, lightpen, etc. Examples of different kinds of output devices 911 include a speaker, printer, etc. One specific type of output device which is typically included in a computer system is a display device 913. Display devices 913 used with embodiments disclosed herein may utilize any suitable image projection technology, such as a cathode ray tube (CRT), liquid crystal display (LCD), light-emitting diode (LED), gas plasma, electroluminescence, or the like. A display controller 915 may also be provided, for converting data stored in the memory 905 into text, graphics, and/or moving images (as appropriate) shown on the display device 913.

Of course, FIG. 9 illustrates only one possible configuration of a computer system 901. Various other architectures and components may be utilized.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed is:

1. A method for heuristics-based load balancing of hybrid PDL/raster printing, the method being implemented by a raster image processing control unit, the method comprising:
in response to a print job being generated on a host, distributing raster image processing of a set of print job segments among a plurality of raster image processing units;
monitoring the availability of the plurality of raster image processing units;
determining that a raster image processing unit from among the plurality of raster image processing units is available to perform additional raster image processing; and
effecting rasterization of a next print job segment by the available raster image processing unit.

2. The method of claim 1, further comprising:
receiving graphics commands corresponding to the print job; and
sorting the graphics commands into the set of print job segments.

3. The method of claim 1, wherein each print job segment is a page band.

4. The method of claim 1, wherein the raster image processing of the set of print job segments is distributed arbitrarily among the plurality of raster image processing units.

5. The method of claim 1, wherein after the raster image processing of the set of print job segments has been distributed among the plurality of raster image processing units, the step of effecting rasterization of the next print job segment by the available raster image processing unit is performed whenever it is determined that one of the plurality of raster image processing units is available to perform additional raster image processing until all print job segments of the print job have been rasterized.

6. The method of claim 1, wherein there are N available raster image processing units, and wherein distributing the raster image processing of the set of print job segments comprises:
instructing the host to rasterize first graphics commands that correspond to a single print job segment; and
instructing the host to render second graphics commands that correspond to N−1 print job segments into page description language data.

7. The method of claim 1, wherein effecting rasterization of the next print job segment comprises:
if the available raster image processing unit is located on the host, instructing the host to rasterize graphics commands that correspond to the next print job segment; and
if the available raster image processing unit is not located on the host, instructing the host to render the graphics commands that correspond to the next print job segment into page description language data.

8. The method of claim 1, wherein the raster image processing control unit is located on the host.

9. The method of claim 1, wherein the raster image processing control unit is located on a print server that is in electronic communication with the host.

10. The method of claim 1, wherein monitoring the availability of the plurality of raster image processing units comprises waiting to receive availability notification messages from the plurality of raster image processing units.

11. The method of claim 1, wherein monitoring the availability of the plurality of raster image processing units comprises sending availability inquiries to the plurality of raster image processing units.

12. The method of claim 1, wherein determining that a raster image processing unit is available to perform additional raster image processing comprises receiving an availability notification message from the raster image processing unit.

13. The method of claim 1, wherein the plurality of raster image processing units comprises a host's raster image processing unit and a printing device's raster image processing unit.

14. The method of claim 13, wherein the plurality of raster image processing units further comprises a print server's raster image processing unit.

15. The method of claim 14, wherein the plurality of raster image processing units further comprises a raster processing unit that is located on an additional host.

16. The method of claim 14, wherein the plurality of raster image processing units further comprises a raster processing unit that is located on a side server.

17. The method of claim 1, further comprising receiving a request from a printing device driver for instructions regarding how to process graphics commands that correspond to the print job.

18. The method of claim 1, further comprising instructing the printing device driver to divide the print job into the print job segments.

19. The method of claim 1, further comprising identifying the plurality of raster image processing units.

20. A computer system that is configured to implement a method for heuristics-based load balancing of hybrid PDL/raster printing, the computer system comprising:
a processor;
memory in electronic communication with the processor;
instructions stored in the memory, the instructions being executable to implement a method comprising:
in response to a print job being generated on a host, distributing raster image processing of a set of print job segments among a plurality of raster image processing units;
monitoring the availability of the plurality of raster image processing units;
determining that a raster image processing unit from among the plurality of raster image processing units is available to perform additional raster image processing; and
effecting rasterization of a next print job segment by the available raster image processing unit.

21. A computer-readable medium comprising executable instructions for implementing a method for heuristics-based load balancing of hybrid PDL/raster printing, the method comprising:
in response to a print job being generated on a host, distributing raster image processing of a set of print job segments among a plurality of raster image processing units;
monitoring the availability of the plurality of raster image processing units;
determining that a raster image processing unit from among the plurality of raster image processing units is available to perform additional raster image processing; and
effecting rasterization of a next print job segment by the available raster image processing unit.
